(19) United States
(12) Patent Application Publication
(10) Pub. No.: US 2015/0016533 A1
(43) Pub. Date: Jan. 15, 2015

(54) INTRA MOTION COMPENSATION EXTENSIONS

(71) Applicant: QUALCOMM Incorporated, San Diego, CA (US)

(72) Inventors: Chao Pang, San Diego, CA (US); Joel Sole Rojals, La Jolla, CA (US); Marta Karczewicz, San Diego, CA (US)

(21) Appl. No.: 14/328,498

(22) Filed: Jul. 10, 2014

Related U.S. Application Data
(60) Provisional application No. 61/845,832, filed on Jul. 12, 2013.
(60) Provisional application No. 61/846,976, filed on Jul. 16, 2013.

(51) Int. Cl. H04N 19/51; H04N 19/583

(52) U.S. Cl. CPC H04N 19/00684; H04N 19/00733
USPC 375/240.16

(57) ABSTRACT

A video coder comprising one or more processors determines that a current block of the video data is encoded using an intra motion compensation (IMC) mode, wherein the current block is in a frame of video; determines an offset vector for a first color component of the current block of the video data; locates, in the frame of video, a reference block of the first color component using the offset vector; modifies the offset vector to generate a modified offset vector in response to the offset vector pointing to a sub-pixel position for a second color component of the current block of video data; locates, in the frame of video, a reference block for the second color component using the modified offset vector; and codes the current block based on the reference block for the first color component and the reference block for the second color component.

This application claims the benefit of

U.S. Provisional Application No. 61/845,832 filed 12 Jul. 2013, and

U.S. Provisional Application No. 61/846,976 file 16 Jul. 2013, the entire content of each of which is hereby incorporated by reference.

### TECHNICAL FIELD

This disclosure relates to video coding and, more particularly, prediction of video blocks based on other video blocks.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

This disclosure introduces techniques related to intra mode compensation (IMC) coding. In IMC coding, a video encoder searches for a predictive block in the same frame or picture as the block being coded, as in an intra prediction mode, but the video encoder searches a wider search area and not just the neighboring rows and columns, as in an inter prediction mode. A video decoder decodes the block by locating the same predictive block determined by the video encoder.

According to one example, a method of decoding video data includes determining that a current block of the video data is encoded using an intra motion compensation (IMC) mode, wherein the current block is in a frame of video; determining an offset vector for a first color component of the current block of the video data; locating, in the frame of video, a reference block of the first color component using the offset vector; modifying the offset vector to generate a modified offset vector in response to the offset vector pointing to a sub-pixel position for a second color component of the current block of video data; locating, in the frame of video, a reference block for the second color component using the modified offset vector; and, decoding the current block based on the reference block for the first color component and the reference block for the second color component.

According to another example, a method of encoding video data includes determining that a current block of video data is to be encoded using an intra motion compensation (IMC) mode; determining an offset vector for a first color component of the current block of the video data; locating, in the frame of video, a reference block of the first color component using the offset vector; modifying the offset vector to generate a modified offset vector in response to the offset vector pointing to a sub-pixel position for a second color component of the current block of video data; locating, in the frame of video, a reference block for the second color component using the modified offset vector; and, generating for inclusion in an encoded bitstream of video data one or more syntax elements identifying the offset vector.

According to another example, an apparatus that performs video coding includes a memory storing video data; and a video coder comprising one or more processors configured to determine that a current block of the video data is encoded using an intra motion compensation (IMC) mode, wherein the current block is in a frame of video; determine an offset vector for a first color component of the current block of the video data; locate, in the frame of video, a reference block of the first color component using the offset vector; modify the offset vector to generate a modified offset vector in response to the offset vector pointing to a sub-pixel position for a second color component of the current block of video data; locate, in the frame of video, a reference block for the second color component using the modified offset vector; and, code the current block based on the reference block for the first color component and the reference block for the second color component.

According to another example, an apparatus that performs video coding, includes means for determining that a current block of the video data is encoded using an intra motion compensation (IMC) mode, wherein the current block is in a frame of video; means for determining an offset vector for a first color component of the current block of the video data; means for locating, in the frame of video, a reference block of the first color component using the offset vector; means for modifying the offset vector to generate a modified offset vector in response to the offset vector pointing to a sub-pixel position for a second color component of the current block of video data; means for locating, in the frame of video, a reference block for the second color component using the modified offset vector; and, means for coding the current block based on the reference block for the first color component and the reference block for the second color component.

According to another example, a computer-readable medium stores instructions that when executed by one or more processors cause the one or more processors to determine that a current block of the video data is encoded using an intra motion compensation (IMC) mode, wherein the current block is in a frame of video; determine an offset vector for a first color component of the current block of the video data; locate, in the frame of video, a reference block of the first color component using the offset vector; modify the offset vector to generate a modified offset vector in response to the offset vector pointing to a sub-pixel position for a second color component of the current block of video data; locate, in the frame of video, a reference block for the second color component using the modified offset vector; and, code the current block based on the reference block for the first color component and the reference block for the second color component.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques described in this disclosure.

FIGS. 2A-2C are conceptual diagrams illustrating different sample formats for video data.

FIG. 3 is a conceptual diagram illustrating a 16×16 coding unit formatted according to a 4:2:0 sample format.

FIG. 4 is a conceptual diagram illustrating a 16×16 coding unit formatted according to a 4:2:2 sample format.

FIG. 5 shows a conceptual illustration of the intra motion compensation (IMC) mode.

FIG. 6 is a block diagram illustrating an example video encoder that may implement the techniques described in this disclosure.

FIG. 7 is a block diagram illustrating an example video decoder that may implement the techniques described in this disclosure.

FIG. 8 is a flowchart showing an example of a method of coding video data according to the techniques of this disclosure.

### DETAILED DESCRIPTION

Various video coding standards, including the recently developed High Efficiency Video Coding (HEVC) standard include predictive coding modes for video blocks, where a block currently being coded is predicted based on an already coded block of video data. In an intra prediction mode, the current block is predicted based on one or more previously coded, neighboring blocks in the same picture as the current block, while in an inter prediction mode the current block is predicted based on an already coded block in a different picture. In inter prediction mode, the process of determining a block of a previously coded frame to use as a predictive block is sometimes referred to as motion estimation, which is generally performed by a video encoder, and the process of identifying and retrieving a predictive block is sometimes referred to as motion compensation, which is performed by both video encoders and video decoders.

A video encoder typically determines how to code a sequence of video data by coding the video using multiple coding scenarios and identifying the coding scenario that produces a desirable rate-distortion tradeoff. When testing intra prediction coding scenarios for a particular video block, a video encoder typically tests the neighboring row of pixels (i.e. the row of pixels immediately above the block being coded) and tests the neighboring column of pixels (i.e. the column of pixels immediately to the left of the block being coded). In contrast, when testing inter prediction scenarios, the video encoder typically identifies candidate predictive blocks in a much larger search area, where the search area corresponds to video blocks in a previously coded frame of video data.

It has been discovered, however, that for certain types of video images, such as video images that include text, symbols, or repetitive patterns, coding gains can be achieved relative to intra prediction and inter prediction by using an intra motion compensation (IMC) mode, which is sometimes also referred to as intra block copy (IBC) mode. In this disclosure, the terms IMC mode and IBC mode are interchangeable. For instance, the term IMC mode was originally used, but later modified to IBC mode. In an IMC mode, a video encoder searches for a predictive block in the same frame or picture as the block being coded, as in an intra prediction mode, but the video encoder searches a wider search area and not just the neighboring rows and columns, as in an inter prediction mode.

In IMC mode, the video encoder may determine an offset vector, also referred to sometimes as a motion vector or block vector, for identifying the predictive block within the same frame or picture as the block being predicted. The offset vector includes, for example, an x-component and a y-component, where the x-component identifies the horizontal displacement between a video block being predicted and the predictive block, and where the y-component identifies a vertical displacement between the video block being predicted and the predictive block. The video encoder signals, in the encoded bitstream, the determined offset vector so that a video decoder, when decoding the encoded bitstream, can identify the predictive block selected by the video encoder.

This disclosure introduces techniques that may improve the performance of IMC coding and/or simplify the system design of systems that utilize an IMC coding mode. According to one technique, the length of a codeword used to signal a component, such as an x-component or y-component, of a motion vector may be dependent on a size of the search region used for the IMC coding mode and/or a size of the coding tree unit that includes the block being predicted. In this manner, fixed length codewords may be used to signal the components of the offset vector, but the length of the fixed-length codeword may be scenario-dependent. The length of the fixed length codewords may, for example, be different for x-components and y-components. By using smaller fixed-length codewords in some coding scenarios, the bit overhead associated with signaling the offset vector for an IMC coding mode may be reduced.

According to another aspect of the techniques of this disclosure, a video coder may determine an offset vector (e.g. for a first color component) for a block of video data being coded in an IMC mode, and if the offset vector points to a sub-pixel position (e.g. for either a first or second color component), the offset vector may be modified to point to an integer pixel position or to point to a less precise sub-pixel position. As will be explained in greater detail below, an offset vector determined for a first color component may need to be scaled before being used to locate a predictive block for a second color component. The scaled offset vector may point to a sub-pixel position of the second color component even if the original offset vector points to an integer pixel position for the first color component. In other examples, a scaled offset vector may point to a higher precision pixel position for the second offset vector than the offset vector pointed to for the first color component.

According to the techniques of this disclosure, an offset vector and/or modified offset vector may be rounded to point to an integer pixel position or to a less precise pixel position. Pointing to an integer pixel position may eliminate the need to perform interpolation filtering, while pointing a less precise sub-pixel position may reduce the complexity of an interpolation filter relative to the interpolation filters used for more-precise sub-pixel position. Avoiding interpolation filtering or using a less complex interpolation filter may potentially reduce the overall complexity (i.e. memory usage, number of operations, etc.) for implementing an IMC coding mode.

According to another aspect of the techniques of this disclosure, a maximum coding unit (CU) size for an IMC coding mode may be set to a size that is smaller than a maximum CTU size. Thus, IMC coding may only be performed for CUs that are the same size as or smaller than the maximum CU size for IMC coding. In some implementations, having a maximum CU size for IMC coding smaller than a maximum CTU size may be an encoder-side optimization so that the speed with which video data is encoded is increased by not evaluating IMC coding scenarios for blocks of video data that are larger than the maximum CU size for IMC coding. In this implementation, the maximum CU size for IMC coding may not need to be signaled to or determined by a video decoder. In other implementations, a video encoder may signal, either explicitly or implicitly, the maximum CU size for IMC coding to a video decoder.

According to another aspect of the techniques of this disclosure, the motion vector coding method for each CU may depend on one or more of the CU size, CU position, and the CTU size. As used in this disclosure, the motion vector coding method may refer to the length of codeword used to code the motion vector, but it also may refer to whether the motion vector is coded using a fixed code or a variable length code, or to some other method for coding the motion vector. CU position may refer to a CU's position within a frame of video data, but CU position may also refer to a CU's position within a CTU. For example, a CU in the bottom right corner of a CTU may potentially need a longer motion vector to identify a predictive block compared to a CU at the top of a CTU. Therefore, the codeword used to code a motion vector for a bottom right CTU may be longer than a codeword used to code a motion vector for a CTU located at the top of the CTU. According to this aspect, the code lengths for the CUs with different sizes or at different positions or different CTU sizes can be different. Note that other processes in the my coding may also depend on the CU size, CU position, and/or the CTU size as well, such as code type or context models for arithmetic codes.

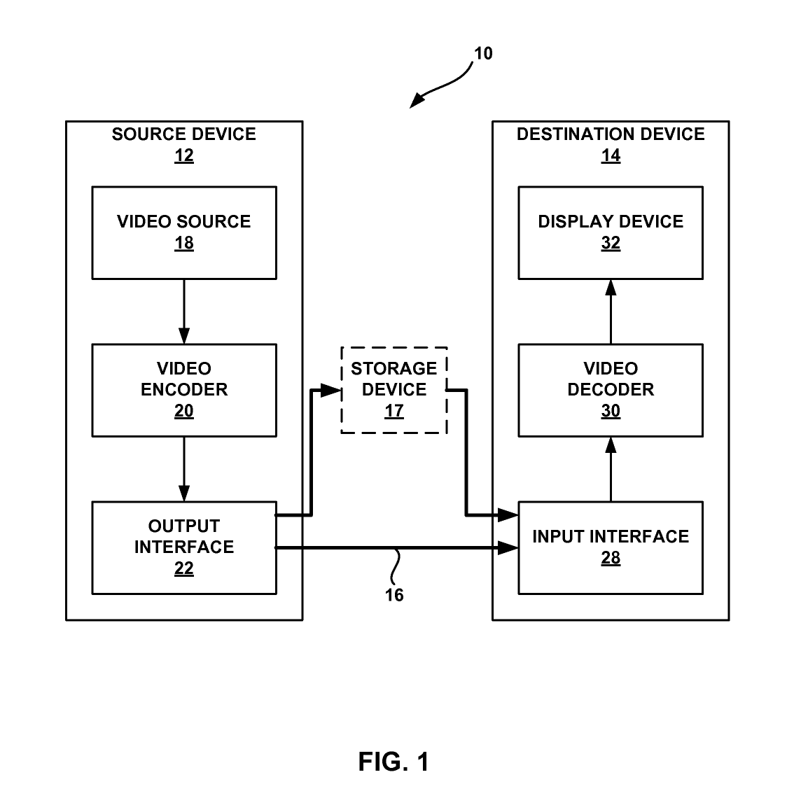

FIG. 1 is a block diagram illustrating an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

Alternatively, encoded data may be output from output interface 22 to a storage device 17. Similarly, encoded data may be accessed from storage device 17 by input interface. Storage device 17 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 17 may correspond to a file server or another intermediate storage device that may hold the encoded video generated by source device 12. Destination device 14 may access stored video data from storage device 17 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 17 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 17 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 17, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC), and may conform to the HEVC Test Model (HM). A working draft of the HEVC standard, referred to as “HEVC Working Draft 10” or “HEVC WD10,” is described in Bross et al., “Editors' proposed corrections to HEVC version 1,” Joint Collaborative Team on Video Coding (JCT-VC) of ITU-T SG16 WP3 and ISO/IEC JTC1/SC29/WG11, 13^{th} Meeting, Incheon, KR, April 2013. The techniques described in this disclosure may also operate according to extensions of the HEVC standard that are currently in development.

Alternatively or additionally, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC developed the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. A treeblock has a similar purpose as a macroblock of the H.264 standard. A slice includes a number of consecutive treeblocks in coding order. A video frame or picture may be partitioned into one or more slices. Each treeblock may be split into coding units (CUs) according to a quadtree. For example, a treeblock, as a root node of the quadtree, may be split into four child nodes, and each child node may in turn be a parent node and be split into another four child nodes. A final, unsplit child node, as a leaf node of the quadtree, comprises a coding node, i.e., a coded video block. Syntax data associated with a coded bitstream may define a maximum number of times a treeblock may be split, and may also define a minimum size of the coding nodes.

A CU is defined as basic coding unit in HEVC. In HEVC, a frame is first divided into a number of square units called a CTU (Coding Tree Unit). Let CTU size be 2N×2N. Each CTU can be divided into 4 N×N CUs, and each CU can be further divided into 4 (N/2)×(N/2) units. The block splitting can continue in the same way until it reaches the predefined maximum splitting level or the allowed smallest CU size. The size of the CTU, the levels of further splitting CTU into CU and the smallest size of CU are defined in the encoding configurations, and will be sent to video decoder 30 or may be known to both video encoder 20 and video decoder 30.

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

In general, a PU includes data related to the prediction process. For example, when the PU is intra-mode encoded, the PU may include data describing an intra-prediction mode for the PU. As another example, when the PU is inter-mode encoded, the PU may include data defining a motion vector for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

In general, a TU is used for the transform and quantization processes. A given CU having one or more PUs may also include one or more transform units (TUs). Following prediction, video encoder 20 may calculate residual values corresponding to the PU. The residual values comprise pixel difference values that may be transformed into transform coefficients, quantized, and scanned using the TUs to produce serialized transform coefficients for entropy coding. This disclosure typically uses the term “video block” to refer to a coding node of a CU. In some specific cases, this disclosure may also use the term “video block” to refer to a treeblock, i.e., LCU, or a CU, which includes a coding node and PUs and TUs.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Thus, according to the HEVC, a CU may include one or more prediction units (PUs) and/or one or more transform units (TUs). This disclosure also uses the term “block”, “partition,” or “portion” to refer to any of a CU, PU, or TU. In general, “portion” may refer to any sub-set of a video frame. Further, this disclosure typically uses the term “video block” to refer to a coding node of a CU. In some specific cases, this disclosure may also use the term “video block” to refer to a treeblock, i.e., LCU, or a CU, which includes a coding node and PUs and TUs. Thus, a video block may correspond to a coding node within a CU and video blocks may have fixed or varying sizes, and may differ in size according to a specified coding standard.

A video sampling format, which may also be referred to as a chroma format, may define the number of chroma samples included in a CU with respect to the number of luma samples included in a CU. Depending on the video sampling format for the chroma components, the size, in terms of number of samples, of the U and V components may be the same as or different from the size of the Y component. In the HEVC standard, a value called chroma_format_idc is defined to indicate different sampling formats of the chroma components, relative to the luma component. In HEVC, chroma_format_idc is signaled in the SPS. Table 1 illustrates the relationship between values of chroma_format_idc and associated chroma formats.

TABLE 1
different chroma formats defined in HEVC

| chroma_format_idc | chroma format | SubWidthC | SubHeightC |
|---|---|---|---|
| 0 | monochrome | — | — |
| 1 | 4:2:0 | 2 | 2 |
| 2 | 4:2:2 | 2 | 1 |
| 3 | 4:4:4 | 1 | 1 |

In Table 1, the variables SubWidthC and SubHeightC can be used to indicate the horizontal and vertical sampling rate ratio between the number of samples for the luma component and the number of samples for each chroma component. In the chroma formats described in Table 1, the two chroma components have the same sampling rate. Thus, in 4:2:0 sampling, each of the two chroma arrays has half the height and half the width of the luma array, while in 4:2:2 sampling, each of the two chroma arrays has the same height and half the width of the luma array. In 4:4:4 sampling, each of the two chroma arrays, may have the same height and width as the luma array, or in some instances, the three color planes may all be separately processed as monochrome sampled pictures.

In the example of Table 1, for the 4:2:0 format, the sampling rate for the luma component is twice that of the chroma components for both the horizontal and vertical directions. As a result, for a coding unit formatted according to the 4:2:0 format, the width and height of an array of samples for the luma component are twice that of each array of samples for the chroma components. Similarly, for a coding unit formatted according to the 4:2:2 format, the width of an array of samples for the luma component is twice that of the width of an array of samples for each chroma component, but the height of the array of samples for the luma component is equal to the height of an array of samples for each chroma component. For a coding unit formatted according to the 4:4:4 format, an array of samples for the luma component has the same width and height as an array of samples for each chroma component. It should be noted that in addition to the YUV color space, video data can be defined according to an RGB space color. In this manner, the chroma formats described herein may apply to either the YUV or RGB color space. RGB chroma formats are typically sampled such that the number of red samples, the number of green samples and the number of blue samples are equal. Thus, the term “4:4:4 chroma format” as used herein may refer to either a YUV color space or an RGB color space wherein the number of samples is equal for all color components.

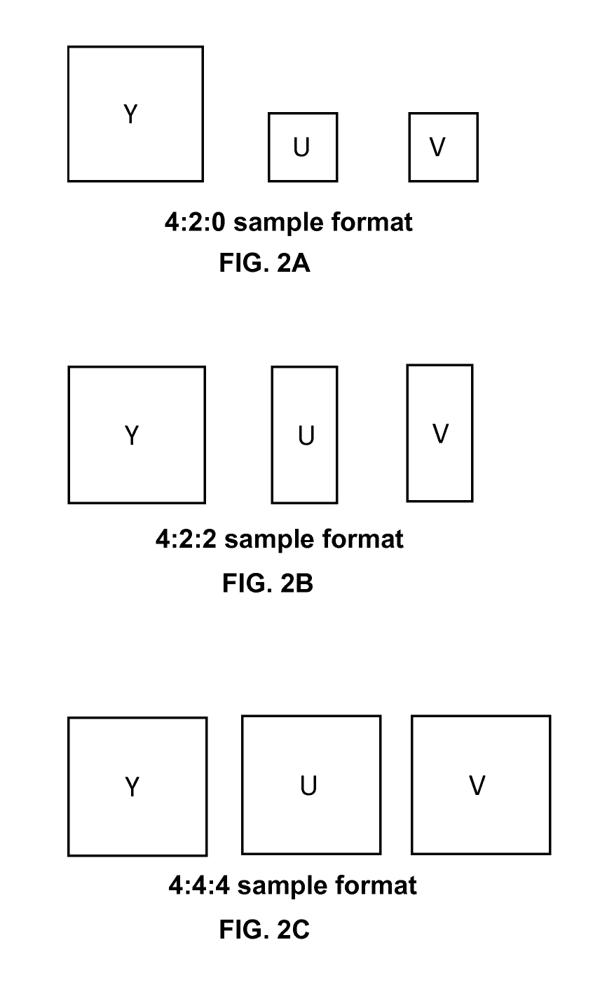

FIGS. 2A-2C are conceptual diagrams illustrating different sample formats for video data. FIG. 2A is a conceptual diagram illustrating the 4:2:0 sample format. As illustrated in FIG. 2A, for the 4:2:0 sample format, the chroma components are one quarter of the size of the luma component. Thus, for a CU formatted according to the 4:2:0 sample format, there are four luma samples for every sample of a chroma component. FIG. 2B is a conceptual diagram illustrating the 4:2:2 sample format. As illustrated in FIG. 2B, for the 4:2:2 sample format, the chroma components are one half of the size of the luma component. Thus, for a CU formatted according to the 4:2:2 sample format, there are two luma samples for every sample of a chroma component. FIG. 2C is a conceptual diagram illustrating the 4:4:4 sample format. As illustrated in FIG. 2C, for the 4:4:4 sample format, the chroma components are the same size of the luma component. Thus, for a CU formatted according to the 4:4:4 sample format, there is one luma sample for every sample of a chroma component.

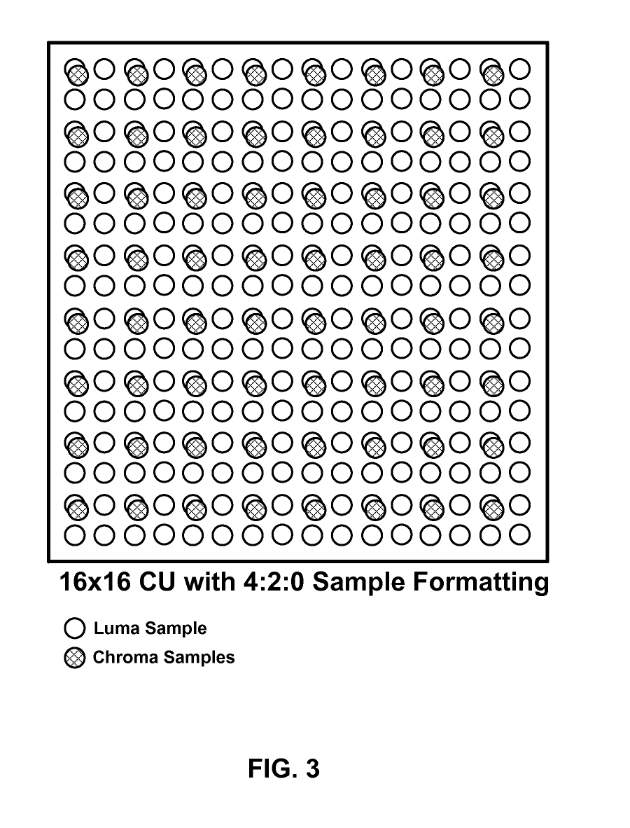

FIG. 3 is a conceptual diagram illustrating an example of a 16×16 coding unit formatted according to a 4:2:0 sample format. FIG. 3 illustrates the relative position of chroma samples with respect to luma samples within a CU. As described above, a CU is typically defined according to the number of horizontal and vertical luma samples. Thus, as illustrated in FIG. 3, a 16×16 CU formatted according to the 4:2:0 sample format includes 16×16 samples of luma components and 8×8 samples for each chroma component. Further, as described above, a CU may be partitioned into smaller CUs. For example, the CU illustrated in FIG. 3 may be partitioned into four 8×8 CUs, where each 8×8 CU includes 8×8 samples for the luma component and 4×4 samples for each chroma component.

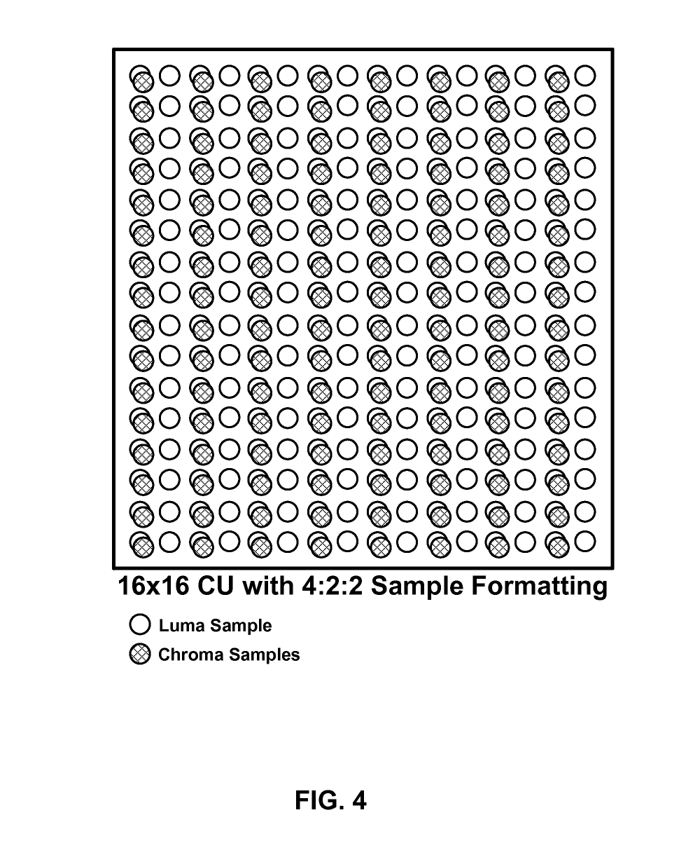

FIG. 4 is a conceptual diagram illustrating an example of a 16×16 coding unit formatted according to a 4:2:2 sample format. FIG. 4 illustrates the relative position of chroma samples with respect to luma samples within a CU. As described above, a CU is typically defined according to the number of horizontal and vertical luma samples. Thus, as illustrated in FIG. 4, a 16×16 CU formatted according to the 4:2:2 sample format includes 16×16 samples of luma components and 8×16 samples for each chroma component. Further, as described above, a CU may be partitioned into smaller CUs. For example, the CU illustrated in FIG. 4 may be partitioned into four 8×8 CUs, where each CU includes 8×8 samples for the luma component and 4×8 samples for each chroma component.

Following intra-predictive or inter-predictive coding using the PUs of a CU, video encoder 20 may calculate residual data for the TUs of the CU. The PUs may comprise pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context adaptive variable length coding (CAVLC), context adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

According to one example technique of this disclosure, video decoder 30 may decode a current block of video data using an IMC mode. Video decoder 30 may determine, for the current block of video data, a length of a codeword used to signal a component of an offset vector and based on the length of the codeword, code the offset vector. The component of the offset vector being coded may be either an x-component or a y-component, and the length of the codeword used to signal one component may be different than a length of a second codeword used to signal the other of the x-component and the y-component.

Video decoder 30 may, for example, determine the length of the codeword used to signal the component of the offset vector by determining the length of the codeword based on a size of a search region used to perform IMC for the current block of video data. The size of the search region may, for example, be determined based on one or more of a distance between a pixel of the current block and a top boundary of the search region, a distance between a pixel of a current block and a left boundary of the search region, a distance between a pixel of a current block and a right boundary of the search region.

Additionally or alternatively, video decoder 30 may determine the length of the codeword used to signal the component of the offset vector based on one or more of a size of a coding tree unit comprising the current block, a location of the current block in a coding tree unit (CTU), or a location of the current block in a frame of video data, based on a size of the current block.

According to another example technique of this disclosure, video decoder 30 may decode a current block of video data using an IMC mode. Video decoder 30 may determine for the current block of video data an offset vector (e.g., an offset vector for a luma component of the current block for which video encoder 20 signaled information that video decoder 30 uses to determine the offset vector), and in response to the offset vector pointing to a sub-pixel position (e.g., in response to the offset vector pointing to a sub-pixel position within the chroma sample), modify the offset vector to generate a modified offset vector that is used for locating a reference block for the chroma component of the current block. The modified offset vector may, for example, point to an integer pixel position or point to a pixel position that is a lower precision position than the sub-pixel position.

According to another example technique of this disclosure, video decoder 30 may determine for a current block of video data a maximum CTU size. Video decoder 30 may determine for the current block of video data a maximum CU size for an IMC mode. The maximum CU size for the IMC mode may be less than the maximum CTU size. Video decoder 30 may code the current block of video data based on the maximum CU size for the IMC mode. Coding the current block of video data based on the maximum CU size for the IMC mode may, for example, include one or more of not coding the current block of video data in the IMC mode in response to a size for the current block of video data being greater than the maximum CU size for the IMC mode or coding the current block of video data in the IMC mode in response to a size for the current block of video data being less than or equal to the maximum CU size for the IMC mode. The maximum CU size for the IMC mode may, for example, be signaled in an encoded video bitstream or determined based on statistics of already coded video data.

According to another example technique of this disclosure, video decoder 30 may code a current block of video data using an IMC mode. Based on one or more of a size of the current block, a position of the current block, and a size of a CTU comprising the current block, video decoder 30 may determine for the current block of video data a coding method for coding an offset vector and code the offset vector based on the determined coding method. The coding method for coding the offset vector may, for example, include one of or a combination of fixed length coding, variable length coding, arithmetic coding, and context-based coding. The position of the current block may, for example, be the position within the CTU or the position within a frame of video data.

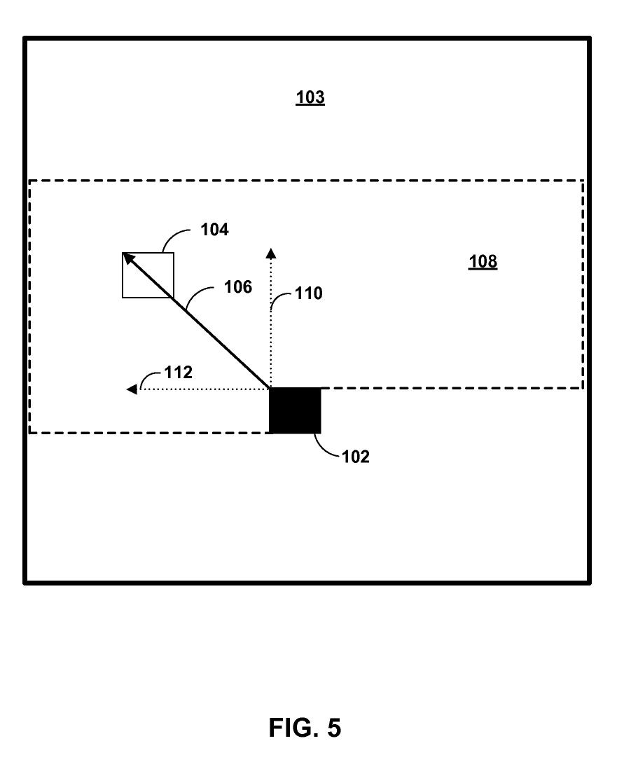

FIG. 5 shows a conceptual illustration of the intra motion compensation (IMC) mode. As noted above, IMC mode is the same as intra block copy (IBC) mode. Video encoder 20 and video decoder 30 may, for example be configured to encode and decode blocks of video data using an IMC mode. Many applications, such as remote desktop, remote gaming, wireless displays, automotive infotainment, cloud computing, etc., are becoming routine in people's daily lives, and the coding efficiency when coding such content may be improved by the use of an IMC mode. System 10 of FIG. 1 may represent devices configured to execute any of these applications. Video contents in these applications are often combinations of natural content, text, artificial graphics, etc. In text and artificial graphics regions of video frames, repeated patterns (such as characters, icons, symbols, etc.) often exist. As introduced above, IMC is a dedicated technique which enables removing this kind of redundancy and potentially improving the intra-frame coding efficiency as reported in JCT-VC M0350. As illustrated in FIG. 5, for the coding units (CUs) which use IMC, the prediction signals are obtained from the already reconstructed region in the same frame. In the end, the offset vector, which indicates the position of the prediction signal displaced from the current CU, together with the residue signal are encoded.

For instance, FIG. 5 illustrates an example technique for predicting a current block 102 of video data within a current picture 103 according to a mode for intra prediction of blocks of video data from predictive blocks of video data within the same picture according to this disclosure, e.g., according to an Intra MC mode in accordance with the techniques of this disclosure. FIG. 5 illustrates a predictive block of video data 104 within current picture 103. A video coder, e.g., video encoder 20 and/or video decoder 30, may use predictive video block 104 to predict current video block 102 according to an Intra MC mode in accordance with the techniques of this disclosure.

Video encoder 20 selects predictive video block 104 for predicting current video block 102 from a set of previously reconstructed blocks of video data. Video encoder 20 reconstructs blocks of video data by inverse quantizing and inverse transforming the video data that is also included in the encoded video bitstream, and summing the resulting residual blocks with the predictive blocks used to predict the reconstructed blocks of video data. In the example of FIG. 5, intended region 108 within picture 103, which may also be referred to as an “intended area” or “raster area,” includes the set of previously reconstructed video blocks. Video encoder 20 may define intended region 108 within picture 103 in variety of ways, as described in greater detail below. Video encoder 20 may select predictive video block 104 to predict current video block 102 from among the video blocks in intended region 108 based on an analysis of the relative efficiency and accuracy of predicting and coding current video block 102 based on various video blocks within intended region 108.

Video encoder 20 determines two-dimensional vector 106 representing the location or displacement of predictive video block 104 relative to current video block 102. Two-dimensional vector 106, which is an example of an offset vector, includes horizontal displacement component 112 and vertical displacement component 110, which respectively represent the horizontal and vertical displacement of predictive video block 104 relative to current video block 102. Video encoder 20 may include one or more syntax elements that identify or define two-dimensional vector 106, e.g., that define horizontal displacement component 112 and vertical displacement component 110, in the encoded video bitstream. Video decoder 30 may decode the one or more syntax elements to determine two-dimensional vector 106, and use the determined vector to identify predictive video block 104 for current video block 102.

In some examples, the resolution of two-dimensional vector 106 can be integer pixel, e.g., be constrained to have integer pixel resolution. In such examples, the resolution of horizontal displacement component 112 and vertical displacement component 110 will be integer pixel. In such examples, video encoder 20 and video decoder 30 need not interpolate pixel values of predictive video block 104 to determine the predictor for current video block 102.

In other examples, the resolution of one or both of horizontal displacement component 112 and vertical displacement component 110 can be sub-pixel. For example, one of components 112 and 110 may have integer pixel resolution, while the other has sub-pixel resolution. In some examples, the resolution of both of horizontal displacement component 112 and vertical displacement component 110 can be sub-pixel, but horizontal displacement component 112 and vertical displacement component 110 may have different resolutions.

In some examples, a video coder, e.g., video encoder 20 and/or video decoder 30, adapts the resolution of horizontal displacement component 112 and vertical displacement component 110 based on a specific level, e.g., block-level, slice-level, or picture-level adaptation. For example, video encoder 20 may signal a flag at the slice level, e.g., in a slice header, that indicates whether the resolution of horizontal displacement component 112 and vertical displacement component 110 is integer pixel resolution or is not integer pixel resolution. If the flag indicates that the resolution of horizontal displacement component 112 and vertical displacement component 110 is not integer pixel resolution, video decoder 30 may infer that the resolution is sub-pixel resolution. In some examples, one or more syntax elements, which are not necessarily a flag, may be transmitted for each slice or other unit of video data to indicate the collective or individual resolutions of horizontal displacement components 112 and/or vertical displacement components 110.

In still other examples, instead of a flag or a syntax element, video encoder 20 may set based on, and video decoder 30 may infer the resolution of horizontal displacement component 112 and/or vertical displacement component 110 from resolution context information. Resolution context information may include, as examples, the color space (e.g., YUV, RGB, or the like), the specific color format (e.g., 4:4:4, 4:2:2, 4:2:0, or the like), the frame size, the frame rate, or the quantization parameter (QP) for the picture or sequence of pictures that include current video block 102. In at least some examples, a video coder may determine the resolution of horizontal displacement component 112 and/or vertical displacement component 110 based on information related to previously coded frames or pictures. In this manner, the resolution of horizontal displacement component 112 and the resolution for vertical displacement component 110 may be pre-defined, signaled, may be inferred from other, side information (e.g., resolution context information), or may be based on already coded frames.

Current video block 102 may be a CU, or a PU of a CU. In some examples, a video coder, e.g., video encoder 20 and/or video decoder 30, may split a CU that is predicted according to IMC into a number of PUs. In such examples, the video coder may determine a respective (e.g., different) two-dimensional vector 106 for each of the PUs of the CU. For example, a video coder may split a 2N×2N CU into two 2N×N PUs, two N×2N PUs, or four N×N PUs. As other examples, a video coder may split a 2N×2N CU into ((N/2)×N+(3N/2)×N) PUs, ((3N/2)×N+(N/2)×N) PUs, (N×(N/2)+N×(3N/2)) PUs, (N×(3N/2)+N×(N/2)) PUs, four (N/2)×2N PUs, or four 2N×(N/2) PUs. In some examples, video coder may predict a 2N×2N CU using a 2N×2N PU.

Current video block 102 includes a luma video block (e.g., luma component) and a chroma video block (e.g., chroma component) corresponding to the luma video block. In some examples, video encoder 20 may only encode one or more syntax elements defining two-dimensional vectors 106 for luma video blocks into the encoded video bitstream. In such examples, video decoder 30 may derive two-dimensional vectors 106 for each of one or more chroma blocks corresponding to a luma block based on the two-dimensional vector signaled for the luma block. In the techniques described in this disclosure, in the derivation of the two-dimensional vectors for the one or more chroma blocks, video decoder 30 may modify the two-dimensional vector for the luma block if the two-dimensional vector for the luma block points to a sub-pixel position within the chroma sample.

Depending on the color format, e.g., color sampling format or chroma sampling format, a video coder may downsample corresponding chroma video blocks relative to the luma video block. Color format 4:4:4 does not include downsampling, meaning that the chroma blocks include the same number of samples in the horizontal and vertical directions as the luma block. Color format 4:2:2 is downsampled in the horizontal direction, meaning that there are half as many samples in the horizontal direction in the chroma blocks relative to the luma block. Color format 4:2:0 is downsampled in the horizontal and vertical directions, meaning that there are half as many samples in the horizontal and vertical directions in the chroma blocks relative to the luma block.

In examples in which video coders determine vectors 106 for chroma video blocks based on vectors 106 for corresponding luma blocks, the video coders may need to modify the luma vector. For example, if a luma vector 106 has integer resolution with horizontal displacement component 112 and/or vertical displacement component 110 being an odd number of pixels, and the color format is 4:2:2 or 4:2:0, the converted luma vector may not point an integer pixel location in the corresponding chroma block. In such examples, video coders may scale the luma vector for use as a chroma vector to predict a corresponding chroma block.

FIG. 5 shows a current CU that is being coded in an IMC mode. A predictive block for the current CU may be obtained from the search region. The search region includes already coded blocks from the same frame as the current CU. Assuming, for example, the frame is being coded in a raster scan order (i.e. left-to-right and top-to-bottom), the already coded blocks of the frame correspond to blocks that are to the left of and above the current CU, as shown in FIG. 5. In some examples, the search region may include all of the already coded blocks in the frame, while in other examples, the search region may include fewer than all of the already coded blocks. The offset vector in FIG. 5, sometimes referred to as a motion vector or prediction vector, identifies the differences between a top-left pixel of the current CU and a top-left pixel of the predictive block (labeled prediction signal in FIG. 5). Thus, by signaling the offset vector in the encoded video bitstream, a video decoder can identify the predictive block for the current CU, when the current CU is coded in an IMC mode.

According to various aspects of the techniques of this disclosure, the motion vector for IMC (referred to as an offset vector) is a 2-D vector (Vx, Vy) with Vx indicating the displacement in the horizontal direction (i.e. x-direction) and Vy indicating the displacement in the vertical direction (i.e. y-direction). The offset vector component Vi (i can be x or y), can be encoded depending on the CTU size. For example, the code lengths and/or binarization methods of Vis may differ for different CTU sizes. For example, if the CTU size is 64×64, then a 6-bits fixed length code may be used. Otherwise, if the CTU size is 32×32, then a 5-bit fixed length code may be used.

Moreover, the coding of the offset vector can be dependent on the search region area as well. Different search region sizes or shapes may lead to different coding methods for the offset vectors. The coding of the offset vector may, for example, be dependent on one or both of the length and width of the search region. The size of the search region may, for example, correspond to a distance between a pixel of the current block and a top boundary of the search region, a left boundary of the search region, and/or a right boundary of the search region. The size of the search region may, for example, be dependent on a blocks location within a slice or frame. A block at the top-left of a frame may, for example, have a smaller search region than a block located at the bottom-right of the frame.

In addition, the above dependencies can be extended to only one offset vector component (i.e. only the x-component or only the y-component) or to both offset vector components. Also, both components might have different binarization. For instance, the horizontal MV can have a 6-bits fixed length code, while the vertical MV may have a 5-bits fixed length code, since the search area contain the left CTU, but may not go up to the above CTU (in order to require line buffers for the above data).

According to other aspects of the techniques of this disclosure, the resolutions of the offset vector component Vi (i can be x or y) can be integer pixel resolution or sub-pixel resolution. When the sub-pixel resolution is used for the offset vector of a certain color component (e.g. Y/U/V, R/G/B), the interpolation filter is used to generate the values at sub-pixels positions.

According to these aspects of the techniques, for any color component (e.g., for luma or chroma blocks), when the resolution of the corresponding offset vectors is sub-pixel, the resolution of the offset vectors may be converted to an integer pixel position or a less precise sub-pixel position. In the case of an integer pixel position, no interpolation filter may be needed, while in the case of a less precise sub-pixel position, a simpler interpolation filter may be used (e.g. simpler compared to the interpolation filter needed for a higher precision sub-pixel position). According to this disclosure, an integer pixel position is a less precise position than a half-pixel position. A half-pixel position is a less precise position than a quarter-pixel position, and so on.

For example, in the 4:2:0 case, when the luma MV (i.e., luma offset vector) is an odd number (e.g., the x and/or y-component is an odd number), then the chroma MV (i.e., chroma offset vector) has sub-pel precision and an interpolation filter is required. However, in the techniques described in this disclosure, the chroma MV (i.e., chroma offset vector) would be rounded to an integer position to avoid the usage of the interpolation filter. The offset vector might be rounded up or down. In other words, video encoder 20 may signal the offset vector for the luma block of the current block to video decoder 30. Video decoder 30 may determine whether using this offset vector (once scaled or otherwise) as an offset vector for a chroma block of the current block would result in the offset vector pointing to a sub-pixel position within the chroma sample of the current picture that includes the current block. If the offset vector points to a sub-pixel position within the chroma sample, video decoder 30 may modify the offset vector to generate a modified offset vector that points to an integer pixel position in the chroma sample or a lower precision position than the sub-pixel position in the chroma sample This method may need less memory bandwidth and number of operations (no filtering) while providing similar performance.

According to various aspects of the techniques of this disclosure, the maximum CU size for IMC can be different from a CTU size. For instance, when the CTU size is 64×64, the maximum CU size for IMC can be set to be 16×16. In some examples, this restriction can be applicable to both video encoder 20 and video decoder 30, or only video encoder 20.

When this kind of technique is applied to both video encoder 20 and video decoder 30, the maximum CU size for IMC may depend on the CTU size, or collected statistics from previous frames. Moreover, the maximum CU size information can be signaled in the bitstream at various levels, such as a picture parameter set (PPS), sequence parameter set (SPS), LCU header, or at some other level. When this technique is applied to both video encoder 20 and video decoder 30, CUs that are larger than the restricted CU size can be set to non-intra-MC CUs in default, and no extra signaling may be needed.

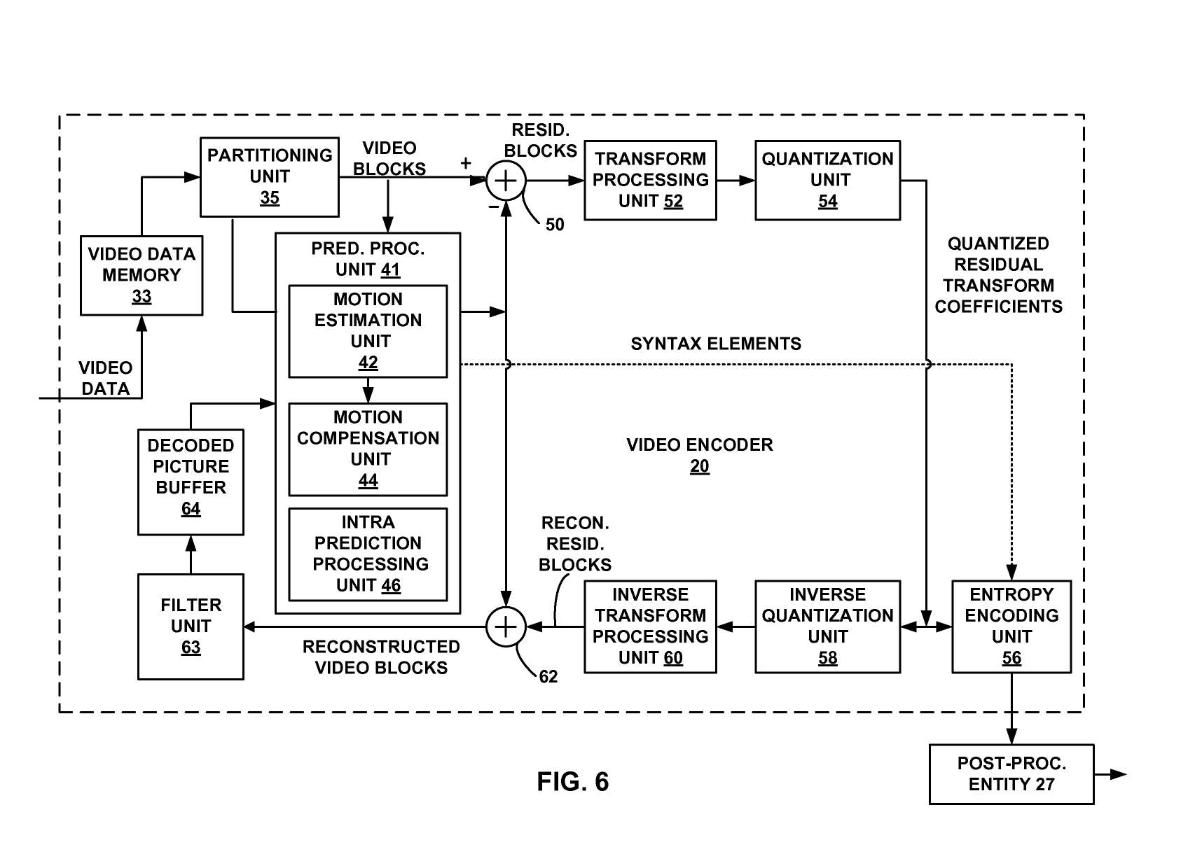

FIG. 6 is a block diagram illustrating an example video encoder 20 that may implement the techniques described in this disclosure. Video encoder 20 may be configured to output video to post-processing entity 27. Post-processing entity 27 is intended to represent an example of a video entity, such as a MANE or splicing/editing device, that may process encoded video data from video encoder 20. In some instances, post-processing entity 27 may be an example of a network entity. In some video encoding systems, post-processing entity 27 and video encoder 20 may be parts of separate devices, while in other instances, the functionality described with respect to post-processing entity 27 may be performed by the same device that comprises video encoder 20. In some example, post-processing entity 27 is an example of storage device 17 of FIG. 1

Video encoder 20 may perform intra-, inter-, and IMC coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes. IMC coding modes, as described above, may remove spatial redundancy from a frame of video data, but unlike tradition intra modes, IMC coding codes may be used to locate predictive blocks in a larger search area within the frame and refer to the predictive blocks with offset vectors, rather than relying on intra-prediction coding modes.

In the example of FIG. 6, video encoder 20 includes video data memory 33, partitioning unit 35, prediction processing unit 41, filter unit 63, decoded picture buffer 64, summer 50, transform processing unit 52, quantization unit 54, and entropy encoding unit 56. Prediction processing unit 41 includes motion estimation unit 42, motion compensation unit 44, and intra-prediction processing unit 46. For video block reconstruction, video encoder 20 also includes inverse quantization unit 58, inverse transform processing unit 60, and summer 62. Filter unit 63 is intended to represent one or more loop filters such as a deblocking filter, an adaptive loop filter (ALF), and a sample adaptive offset (SAO) filter. Although filter unit 63 is shown in FIG. 6 as being an in loop filter, in other configurations, filter unit 63 may be implemented as a post loop filter.

Video data memory 33 may store video data to be encoded by the components of video encoder 20. The video data stored in video data memory 33 may be obtained, for example, from video source 18. Decoded picture buffer 64 may be a reference picture memory that stores reference video data for use in encoding video data by video encoder 20, e.g., in intra-, inter-, or IMC coding modes. Video data memory 33 and decoded picture buffer 64 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 33 and decoded picture buffer 64 may be provided by the same memory device or separate memory devices. In various examples, video data memory 33 may be on-chip with other components of video encoder 20, or off-chip relative to those components.

As shown in FIG. 6, video encoder 20 receives video data and stores the video data in video data memory 33. Partitioning unit 35 partitions the data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra coding modes, one of a plurality of inter coding modes, or one of a plurality of IMC coding modes, for the current video block based on error results (e.g., coding rate and the level of distortion). Prediction processing unit 41 may provide the resulting intra-, inter-, or IMC coded block to summer 50 to generate residual block data and to summer 62 to reconstruct the encoded block for use as a reference picture.

Intra-prediction processing unit 46 within prediction processing unit 41 may perform intra-predictive coding of the current video block relative to one or more neighboring blocks in the same frame or slice as the current block to be coded to provide spatial compression. Motion estimation unit 42 and motion compensation unit 44 within prediction processing unit 41 may perform inter-predictive coding of the current video block relative to one or more predictive blocks in one or more reference pictures to provide temporal compression. Motion estimation unit 42 and motion compensation unit 44 within prediction processing unit 41 may also perform IMC coding of the current video block relative to one or more predictive blocks in the same picture to provide spatial compression.

Motion estimation unit 42 may be configured to determine the inter-prediction mode or IMC mode for a video slice according to a predetermined pattern for a video sequence. The predetermined pattern may designate video slices in the sequence as P slices, B slices or GPB slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture. In the case of IMC coding, a motion vector, which may be referred to as an offset vector in IMC, may indicate the displacement of a PU of a video block within a current video frame or picture relative to a predictive block within the current video frame.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in decoded picture buffer 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in decoded picture buffer 64. Motion estimation unit 42 sends the calculated motion vector to entropy encoding unit 56 and motion compensation unit 44.

According to some techniques of this disclosure, when coding a video block using an IMC mode, motion estimation unit 42 may determine a motion vector, or offset vector, for a luma component of the video block, and determine an offset vector for a chroma component of the video block based on the offset vector for the luma component. In another example, when coding a video block using an IMC mode, motion estimation unit 42 may determine a motion vector, or offset vector, for a chroma component of the video block, and determine an offset vector for a luma component of the video block based on the offset vector for the chroma component. Thus, video encoder 20 may signal in the bitstream only one offset vector, from which offset vectors for both chroma and luma components of the video block may be determined.

Motion compensation, performed by motion compensation unit 44, may involve fetching or generating the predictive block based on the motion vector determined by motion estimation, possibly performing interpolations to sub-pixel precision. Interpolation filtering may generate additional pixel samples from known pixel samples, thus potentially increasing the number of candidate predictive blocks that may be used to code a video block. Upon receiving the motion vector for the PU of the current video block, motion compensation unit 44 may locate the predictive block to which the motion vector points in one of the reference picture lists, or in the case of the IMC coding, within the picture being coded. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

Intra-prediction processing unit 46 may intra-predict a current block, as an alternative to the inter-prediction and IMC performed by motion estimation unit 42 and motion compensation unit 44, as described above. In particular, intra-prediction processing unit 46 may determine an intra-prediction mode to use to encode a current block. In some examples, intra-prediction processing unit 46 may encode a current block using various intra-prediction modes, e.g., during separate encoding passes, and intra-prediction processing unit 46 (or mode select unit 40, in some examples) may select an appropriate intra-prediction mode to use from the tested modes. For example, intra-prediction processing unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction processing unit 46 may calculate ratios from the distortions and rates for the various encoded blocks to determine which intra-prediction mode exhibits the best rate-distortion value for the block.

In any case, after selecting an intra-prediction mode for a block, intra-prediction processing unit 46 may provide information indicative of the selected intra-prediction mode for the block to entropy encoding unit 56. Entropy encoding unit 56 may encode the information indicating the selected intra-prediction mode in accordance with the techniques of this disclosure. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

After prediction processing unit 41 generates the predictive block for the current video block via either inter-prediction, intra-prediction, or IMC, video encoder 20 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within one of the reference picture lists. Motion compensation unit 44 may also apply one or more interpolation filters to the reconstructed residual block to calculate sub-integer pixel values for use in motion estimation. Interpolation filtering may generate additional pixel samples from known pixel samples, thus potentially increasing the number of candidate predictive blocks that may be used to code a video block. Summer 62 adds the reconstructed residual block to the motion compensated prediction block produced by motion compensation unit 44 to produce a reference block for storage in decoded picture buffer 64. The reference block may be used by motion estimation unit 42 and motion compensation unit 44 as a reference block to inter-predict a block in a subsequent video frame or picture.

In this manner, video encoder 20 of FIG. 6 represents an example of a video encoder configured to code a current block of video data using an IMC mode, determine for the current block of video data a length of a codeword used to signal a component of an offset vector, and based on the length of the codeword, code the offset vector. Video encoder 20 may, for example, determine the length of the codeword used to signal the component based on a size of a search region used to perform IMC for the current block of video data and/or based on a size of a CTU that includes the current block.

Video encoder 20 also represents an example of a video encoder configured to code a current block of video data using an IMC mode, determine for the current block of video data an offset vector for a luma component of the current block, and in response to the offset vector pointing to a sub-pixel position within a chroma sample of the current picture that includes the current block, modify the offset vector to generate a modified offset vector a chroma block of the current block. The modified offset vector may, for example, point to an integer pixel position in the chroma sample or point to a pixel position that is a lower precision position than the sub-pixel position in the chroma sample.

Video encoder 20 also represents an example of a video encoder configured to determine for a current block of video data a maximum CTU size and determine for the current block of video data a maximum CU size for an IMC mode, such that the maximum CU size for the IMC mode is less than the maximum CTU size, and code the current block of video data based on the maximum CU size for the IMC mode. In some implementations, video encoder 20 may signal an indication of the maximum CU size for the IMC mode to a video decoder, while in other configurations video encoder 20 may not signal an indication of the maximum CU size for the IMC mode to a video decoder

Video encoder 20 also represents an example of a video encoder configured to code a current block of video data using an IMC mode; based on one or more of a size of the current block, a position of the current block, and a size of a coding tree unit (CTU) comprising the current block, determine for the current block of video data a coding method for coding an offset vector; and based on the coding method, coding the offset vector. The coding method may for example be any of fixed length coding, variable length coding, arithmetic coding, context-based coding, or any other type of coding method used for coding video data. The position of the current block may refer to a position within the CTU or may refer to the position of the current block within a frame of video data.

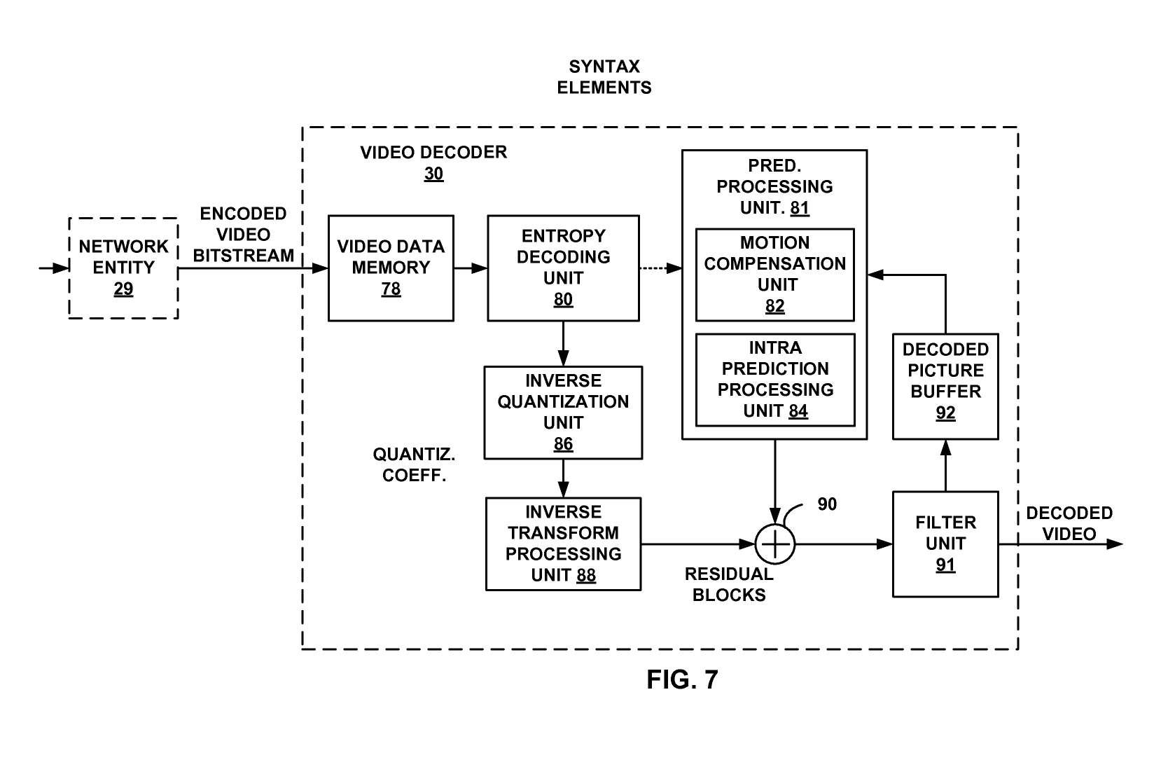

FIG. 7 is a block diagram illustrating an example video decoder 30 that may implement the techniques described in this disclosure. In the example of FIG. 7, video decoder 30 includes a video data memory 78, entropy decoding unit 80, prediction processing unit 81, inverse quantization unit 86, inverse transform processing unit 88, summer 90, filter unit 91, and decoded picture buffer 92. Prediction processing unit 81 includes motion compensation unit 82 and intra-prediction processing unit 84. Video decoder 30 may, in some examples, perform a decoding pass generally reciprocal to the encoding pass described with respect to video encoder 20 from FIG. 6.

During the decoding process, video decoder 30 receives video data, e.g. an encoded video bitstream that represents video blocks of an encoded video slice and associated syntax elements, from video encoder 20. Video decoder 30 may receive the video data from network entity 29 and store the video data in video data memory 78. Video data memory 78 may store video data, such as an encoded video bitstream, to be decoded by the components of video decoder 30. The video data stored in video data memory 78 may be obtained, for example, from storage device 17, e.g., from a local video source, such as a camera, via wired or wireless network communication of video data, or by accessing physical data storage media. Video data memory 78 may form a coded picture buffer that stores encoded video data from an encoded video bitstream. Thus, although shown separately in FIG. 7, video data memory 78 and decoded picture buffer 92 may be provided by the same memory device or separate memory devices. Video data memory 78 and decoded picture buffer 92 may be formed by any of a variety of memory devices, such as dynamic random access memory (DRAM), including synchronous DRAM (SDRAM), magnetoresistive RAM (MRAM), resistive RAM (RRAM), or other types of memory devices. In various examples, video data memory 78 may be on-chip with other components of video decoder 30, or off-chip relative to those components.

Network entity 29 may, for example, be a server, a MANE, a video editor/splicer, or other such device configured to implement one or more of the techniques described above. Network entity 29 may or may not include a video encoder, such as video encoder 20. Some of the techniques described in this disclosure may be implemented by network entity 29 prior to network entity 29 transmitting the encoded video bitstream to video decoder 30. In some video decoding systems, network entity 29 and video decoder 30 may be parts of separate devices, while in other instances, the functionality described with respect to network entity 29 may be performed by the same device that comprises video decoder 30. Network entity 29 may be an example of storage device 17 of FIG. 1 in some cases.

Entropy decoding unit 80 of video decoder 30 entropy decodes the bitstream to generate quantized coefficients, motion vectors, and other syntax elements. Entropy decoding unit 80 forwards the motion vectors and other syntax elements to prediction processing unit 81. Video decoder 30 may receive the syntax elements at the video slice level and/or the video block level.

When the video slice is coded as an intra-coded (I) slice, intra-prediction processing unit 84 of prediction processing unit 81 may generate prediction data for a video block of the current video slice based on a signaled intra prediction mode and data from previously decoded blocks of the current frame or picture. When the video frame is coded as an inter-coded (i.e., B, P or GPB) slice or when a block is IMC coded, motion compensation unit 82 of prediction processing unit 81 produces predictive blocks for a video block of the current video slice based on the motion vectors and other syntax elements received from entropy decoding unit 80. For inter prediction, the predictive blocks may be produced from one of the reference pictures within one of the reference picture lists. Video decoder 30 may construct the reference frame lists, List 0 and List 1, using default construction techniques based on reference pictures stored in decoded picture buffer 92. For IMC coding, the predictive blocks may be produced from the same picture as the block being predicted.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

According to some techniques of this disclosure, when coding a video block using an IMC mode, motion compensation unit 82 may determine a motion vector, or offset vector, for a luma component of the video block, and determine a motion vector for a chroma component of the video block based on the motion vector for the luma component. In another example, when coding a video block using an IMC mode, motion compensation unit 82 may determine a motion vector, or offset vector, for a chroma component of the video block, and determine a motion vector for a luma component of the video block based on the motion vector for the chroma component. Thus, video decoder 30 may receive in the bitstream only one offset vector, from which offset vectors for both chroma and luma components of the video block may be determined.

When decoding a video block using IMC mode, motion compensation unit 82 may, for example, modify a motion vector, referred to as an offset vector for IMC mode, for a luma component to determine an offset vector for a chroma component. Motion compensation unit 82 may, for example, modify one or both of an x-component and y-component of the offset vector of the luma block based on a sampling format for the video block and based on a precision of a sub-pixel position to which the offset vector points. For example, if the video block is coded using the 4:2:2 sampling format, then motion compensation unit 82 may only modify the x-component, not the y-component, of the luma offset vector to determine the offset vector for the chroma component. As can be seen from FIG. 4, in the 4:2:2 sampling format, chroma blocks and luma blocks have the same number of samples in the vertical direction, thus making modification of the y-component potentially unneeded. Motion compensation unit 82 may only modify the luma offset vector, if when used for locating a chroma predictive block, the luma offset vector points to a position without a chroma sample (e.g., at a sub-pixel position in the chroma sample of the current picture that includes the current block). If the luma offset vector, when used to locate a chroma predictive block, points to a position where a chroma sample is present, then motion compensation unit 82 may not modify the luma offset vector.

In another example, if the video block is coded using the 4:2:0 sampling format, then motion compensation unit 82 may modify either or both of the x-component and the y-component of the luma offset vector to determine the offset vector for the chroma component. As can be seen from FIG. 3, in the 4:2:0 sampling format, chroma blocks and luma blocks have a different number of samples in both the vertical direction and the horizontal direction. Motion compensation unit 82 may only modify the luma offset vector, if when used for locating a chroma predictive block, the luma offset vector points to a position without a chroma sample (e.g., at a sub-pixel position in the chroma sample of the current picture that includes the current block). If the luma offset vector, when used to locate a chroma predictive block, points to a position where a chroma sample is present, then motion compensation unit 82 may not modify the luma offset vector.

Motion compensation unit 82 may modify a luma offset vector to generate a modified motion vector, also referred to as a modified offset vector. Motion compensation unit 82 may modify a luma offset vector that, when used to locate a chroma predictive block, points to a sub-pixel position such that the modified offset vector, used for the chroma block, points to a lower resolution sub-pixel position or to an integer pixel position. As one example, a luma offset vector that points to a ⅛ pixel position may be modified to point to a ¼ pixel position, a luma offset vector that points to a ¼ pixel position may be modified to point to a ½ pixel position, etc. In other examples, motion compensation unit 82 may modify the luma offset vector such that the modified offset vector always points to an integer pixel position for locating the chroma reference block. Modifying the luma offset vector to point to a lower resolution sub-pixel position or to an integer pixel position may eliminate the need for some interpolation filtering and/or reduce the complexity of any needed interpolation filtering.

Referring to FIGS. 3 and 4 and assuming the top left sample is located at position (0, 0), a video block has luma samples at both odd and even x positions and both odd and even y positions. In a 4:4:4 sampling format, a video block also has chroma samples at both odd and even x positions and both odd and even y positions. Thus, for a 4:4:4 sampling format, motion compensation unit may use the same offset vector for locating both a luma predictive block and a chroma predictive block. For a 4:2:2 sampling format, as shown in FIG. 4, a video block has chroma samples at both odd and even y positions but only at even x positions. Thus, for the 4:2:2 sampling format, if a luma offset vector points to an odd x position, motion compensation unit 82 may modify the x-component of the luma offset vector to generate a modified offset vector that points to an even x position so that the modified offset vector can be used for locating the reference chroma block for the chroma block of the current block without needing interpolation. Motion compensation unit 82 may modify the x-component, for example, by either rounding up or rounding down to the nearest even x position, i.e. changing the x-component such that it points to either the nearest left x position or nearest right x position. If the luma offset vector already points to an even x position, then no modification may be necessary.

For a 4:2:0 sampling format, as shown in FIG. 3, a video block has chroma samples only at even y positions and only at even x positions. Thus, for the 4:2:0 sampling format, if a luma offset vector points to an odd x position or odd y position, motion compensation unit 82 may modify the x-component or y-component of the luma offset vector to generate a modified offset vector that points to an even x position so that the modified offset vector can be used for locating the reference chroma block for the chroma block of the current block without needing interpolation. Motion compensation unit 82 may modify the x-component, for example, by either rounding up or rounding down to the nearest even x position, i.e. changing the x-component such that it points to either the nearest left x position or nearest right x position. Motion compensation unit 82 may modify the y-component, for example, by either rounding up or rounding down to the nearest even y position, i.e. changing the y-component such that it points to either the nearest above y position or nearest below y position. If the luma offset vector already points to an even x position and an even y position, then no modification may be necessary.

Inverse quantization unit 86 inverse quantizes, i.e., de-quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform processing unit 88 applies an inverse transform, e.g., an inverse DCT, an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, video decoder 30 forms a decoded video block by summing the residual blocks from inverse transform processing unit 88 with the corresponding predictive blocks generated by motion compensation unit 82. Summer 90 represents the component or components that perform this summation operation. If desired, loop filters (either in the coding loop or after the coding loop) may also be used to smooth pixel transitions, or otherwise improve the video quality. Filter unit 91 is intended to represent one or more loop filters such as a deblocking filter, an adaptive loop filter (ALF), and a sample adaptive offset (SAO) filter. Although filter unit 91 is shown in FIG. 7 as being an in loop filter, in other configurations, filter unit 91 may be implemented as a post loop filter. The decoded video blocks in a given frame or picture are then stored in decoded picture buffer 92, which stores reference pictures used for subsequent motion compensation. Decoded picture buffer 92 may be part of a memory that also stores decoded video for later presentation on a display device, such as display device 32 of FIG. 1, or may be separate from such a memory.

In this manner, video decoder 30 of FIG. 7 represents an example of a video decoder configured to code a current block of video data using an IMC mode, determine for the current block of video data a length of a codeword used to signal a component of an offset vector, and based on the length of the codeword, code the offset vector. Video decoder 30 may, for example, decode the current block and receive the codeword. The component of the offset vector may, for example, be an x-component or a y-component. According to one aspect of the techniques of this disclosure, the length of the codeword for an x-component may be different than the length of the codeword for a y-component.

Video decoder 30 may, for example, determine the length of the codeword used to signal the component of the offset vector by determining the length of the codeword based on a size of a search region used to perform IMC for the current block of video data. The size of the search region may, for example, include a distance between a pixel of the current block and a top boundary of the search region, a distance between a pixel of a current block and a left boundary of the search region, and/or a distance between a pixel of a current block and a right boundary of the search region. Video decoder 30 may alternatively or additionally determine the length of the codeword used to signal the component of the offset vector by determining the length of the codeword based on a size of a coding tree unit comprising the current block, determining the length of the codeword based on a location of the current block in a CTU, determining the length of the codeword based on a location of the current block in a frame of video data, and/or determining the length of the codeword based on a size of the current block.

Video decoder 30 also represents an example of a video decoder configured to code a current block of video data using an IMC mode, determine for the current block of video data an offset vector, and in response to the offset vector pointing to a sub-pixel position, modifying the offset vector to generate a modified offset vector. The modified offset vector may, for example, point to an integer pixel position or point to a lower precision sub-pixel position.

Video decoder 30 also represents an example of a video decoder configured to determine for a current block of video data a maximum CTU size and determine for the current block of video data a maximum CU size for an IMC mode, such that the maximum CU size for the IMC mode is less than the maximum CTU size. Video decoder 30 may code the current block of video data based on the maximum CU size for the IMC mode. Video decoder 30 may, for example, be configured to not code the current block of video data in the IMC mode in response to a size for the current block of video data being greater than the maximum CU size for the IMC mode and/or code the current block of video data in the IMC mode in response to a size for the current block of video data being less than or equal to the maximum CU size for the IMC mode. Video decoder 30 may, for example, receiving in the video data, a syntax element signaling the maximum CU size for the IMC mode. Alternatively, video decoder 30 may determine the maximum CU size for the IMC mode based on statistics of already coded video data.

Video decoder 30 also represents an example of a video decoder configured to code a current block of video data using an IMC mode; based on one or more of a size of the current block, a position of the current block, and a size of a coding tree unit (CTU) comprising the current block, determine for the current block of video data a coding method for coding an offset vector; and based on the coding method, coding the offset vector. The coding method may for example be any of fixed length coding, variable length coding, arithmetic coding, context-based coding, or any other type of coding method used for coding video data. The position of the current block may refer to a position within the CTU or may refer to the position of the current block within a frame of video data.

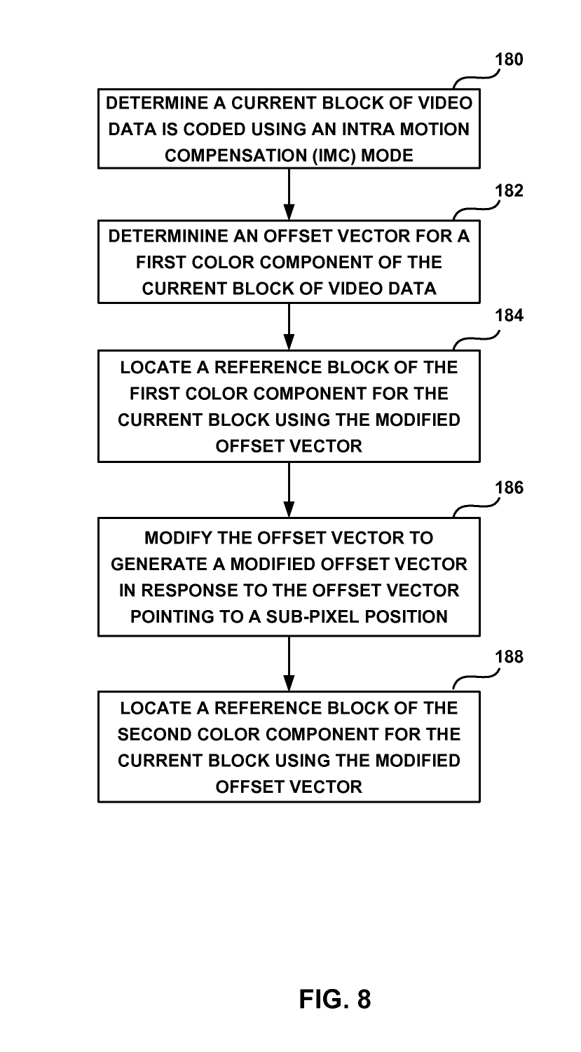

FIG. 8 is a flowchart showing an example of a method of coding (e.g. encoding or decoding) video data according to the techniques of this disclosure. The techniques of FIG. 8 will be described with reference to a generic video coder. The generic video coder may, for example, correspond to video encoder 20 or video decoder 30 described above, although the techniques may also be performed by other types of video encoders and decoders. The techniques of FIG. 8 may, for example, be performed by a video decoder as part of generating decoded video for display. The techniques of FIG. 8 may, for example, be performed by a video encoder as part of encoding video data. A video encoder may, for example, decode encoded video data to generate reference frames for use in encoding other frames.

According to the techniques of FIG. 8, a video coder determines a current block of video data in a frame of video is coded using an IMC mode (180). The current block may, for example, be coded in a 4:4:4 sampling format, a 4:2:0 sampling format, or a 4:2:2 sampling format. A video decoder may, for example, determine that the current block is coded using an IMC mode by receiving, in an encoded bitstream, a syntax element indicating a coding mode for the current block. A video encoder may, for example, determine that the current block should be coded using an IMC mode as part of testing multiple modes to determine a coding mode to use to encode the current block.

According to the example of FIG. 8, the video coder determines an offset vector for a first color component of the current block of video data (182). A video decoder may, for example, determine the offset vector based on syntax elements received in an encoded bitstream, while a video encoder may determine the offset vector as part of searching for a reference block to use to encode the current block. The first color component may, for example, be either a luma component or a chroma component. The video coder locates, in the frame of video, a reference block of the first color component using the offset vector (184).

According to the example of FIG. 8, the video coder modifies the offset vector to generate a modified offset vector in response to the offset vector pointing to a sub-pixel position (186). The video coder may modify the offset vector to point to an integer pixel position or to point to a position that is a lower precision position than the sub-pixel position. In this regard, modifying the offset vector may include more than just scaling the offset vector. For examples, the video coder may scale the offset vector, and in response to the scaled offset vector pointing to a sub-pixel position, may also round the offset vector to point to a less precise sub-pixel position or to an integer pixel position. In response to the offset vector pointing to a sub-pixel position of a chroma reference block, the video coder may modify the offset vector to generate a modified offset vector that points to an integer pixel position of the chroma reference block. In some examples where the current block is coded using a 4:2:2 sampling format, the video coder may modify the offset vector to generate the modified offset vector by modifying the x-component of the offset vector. In some examples where the current block is coded using a 4:2:0 sampling format, the video coder may modify the offset vector to generate the modified offset vector by modifying the x-component, the y-component, or both the x-component and the y-component of the offset vector.

The video coder locates, in the frame of video data, a reference block of the second color component using the modified offset vector (188). In some examples, the video coder may determine the offset vector for a luma component of the current block, and use the modified offset vector to locate a chroma reference block.

A video coder may perform the techniques of FIG. 8 as part of coding the current block of video data. A video encoder may, for example, code the current block of video data by generating for inclusion in an encoded bitstream of video data one or more syntax elements identifying the offset vector. A video decoder may, for example, code the current block by decoding the current block based on the reference block for the first color component and the reference block for the second color component.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
determining that a current block of the video data is encoded using an intra motion compensation (IMC) mode, wherein the current block is in a frame of video;
determining an offset vector for a first color component of the current block of the video data;
locating, in the frame of video, a reference block of the first color component using the offset vector;
modifying the offset vector to generate a modified offset vector in response to the offset vector pointing to a sub-pixel position for a second color component of the current block of video data;
locating, in the frame of video, a reference block for the second color component using the modified offset vector; and,
decoding the current block based on the reference block for the first color component and the reference block for the second color component.

2. The method of claim 1, wherein the first color component comprises a luma component of the current block and the second color component comprises a chroma component of the current block.

3. The method of claim 1, wherein the modified offset vector points to an integer pixel position.

4. The method of claim 1, wherein the modified offset vector points to a pixel position that is a lower precision position than the sub-pixel position.

5. The method of claim 1, wherein the current block is coded using a 4:2:0 sampling format.

6. The method of claim 1, wherein the current block is coded using a 4:2:2 sampling format.

7. The method of claim 1, wherein
modifying the offset vector comprises modifying the offset vector to generate a modified offset vector that points to an integer pixel position of an array of chroma samples in response to the offset vector pointing to a sub-pixel position of the array of chroma samples.

8. The method of claim 1, wherein the offset vector comprises an x-component and a y-component, and wherein the current block is coded using a 4:2:2 sampling format, and wherein modifying the offset vector to generate the modified offset vector comprises modifying the x-component.

9. The method of claim 1, wherein the offset vector comprises an x-component and a y-component, and wherein the current block is coded using a 4:2:0 sampling format, and wherein modifying the offset vector to generate the modified offset vector comprises modifying the y-component.

10. The method of claim 9, wherein modifying the offset vector to generate the modified offset vector further comprises modifying the x-component.

11. A method of encoding video data, the method comprising:
determining that a current block of video data is to be encoded using an intra motion compensation (IMC) mode;
determining an offset vector for a first color component of the current block of the video data;
locating, in the frame of video, a reference block of the first color component using the offset vector;
modifying the offset vector to generate a modified offset vector in response to the offset vector pointing to a sub-pixel position for a second color component of the current block of video data;
locating, in the frame of video, a reference block for the second color component using the modified offset vector; and,
generating for inclusion in an encoded bitstream of video data one or more syntax elements identifying the offset vector.

12. The method of claim 11, wherein the first color component comprises a luma component of the current block and the second color component comprises a chroma component of the current block.

13. The method of claim 11, wherein the modified offset vector points to an integer pixel position.

14. The method of claim 11, wherein the modified offset vector points to a pixel position that is a lower precision position than the sub-pixel position.

15. The method of claim 11, wherein the current block is coded using a 4:2:0 sampling format.

16. The method of claim 11, wherein the current block is coded using a 4:2:2 sampling format.

17. The method of claim 11, wherein
modifying the offset vector comprises modifying the offset vector to generate a modified offset vector that points to an integer pixel position of an array of chroma samples in response to the offset vector pointing to a sub-pixel position of the array of chroma samples.

18. The method of claim 11, wherein the offset vector comprises an x-component and a y-component, and wherein the current block is coded using a 4:2:2 sampling format, and wherein modifying the offset vector to generate the modified offset vector comprises modifying the x-component of the offset vector.

19. The method of claim 11, wherein the offset vector comprises an x-component and a y-component, and wherein the current block is coded using a 4:2:0 sampling format, and wherein modifying the offset vector to generate the modified offset vector comprises modifying the y-component of the offset vector.

20. The method of claim 19, wherein modifying the offset vector to generate the modified offset vector further comprises modifying the x-component of the offset vector.

21. An apparatus that performs video coding, the apparatus comprising:
a memory storing video data; and
a video coder comprising one or more processors configured to:
determine that a current block of the video data is encoded using an intra motion compensation (IMC) mode, wherein the current block is in a frame of video;
determine an offset vector for a first color component of the current block of the video data;
locate, in the frame of video, a reference block of the first color component using the offset vector;
modify the offset vector to generate a modified offset vector in response to the offset vector pointing to a sub-pixel position for a second color component of the current block of video data;
locate, in the frame of video, a reference block for the second color component using the modified offset vector; and,
code the current block based on the reference block for the first color component and the reference block for the second color component.

22. The apparatus of claim 21, wherein the first color component comprises a luma component of the current block and the second color component comprises a chroma component of the current block.

23. The apparatus of claim 21, wherein the modified offset vector points to an integer pixel position.

24. The apparatus of claim 21, wherein the modified offset vector points to a pixel position that is a lower precision position than the sub-pixel position.

25. The apparatus of claim 21, wherein the current block is coded using a 4:2:0 sampling format.

26. The apparatus of claim 21, wherein the current block is coded using a 4:2:2 sampling format.

27. The apparatus of claim 21, wherein the video coder modifies the offset vector by modifying the offset vector to generate a modified offset vector that points to an integer pixel position of an array of chroma samples in response to the offset vector pointing to a sub-pixel position of the array of chroma samples.

28. The apparatus of claim 21, wherein the offset vector comprises an x-component and a y-component, and wherein the current block is coded using a 4:2:2 sampling format, and wherein the video coder modifies the offset vector to generate the modified offset vector by modifying the x-component.

29. The apparatus of claim 21, wherein the offset vector comprises an x-component and a y-component, and wherein the current block is coded using a 4:2:0 sampling format, and wherein the video coder modifies the offset vector to generate the modified offset vector by modifying the y-component.

30. The apparatus of claim 29, wherein modifying the offset vector to generate the modified offset vector further comprises modifying the x-component.

31. The apparatus of claim 21, wherein the video coder comprises a video decoder, and wherein the video coder is further configured to code the current block based on the reference block for the first color component and the reference block for the second color component by decoding the current block based on the reference block for the first color component and the reference block for the second color component.

32. The apparatus of claim 21, wherein the video coder comprises a video encoder, and wherein the video coder is further configured to code the current block based on the reference block by generating for inclusion in an encoded bitstream of video data one or more syntax elements identifying the offset vector.

33. The apparatus of claim 29, wherein the apparatus comprises at least one of:
an integrated circuit;
a microprocessor; and
a wireless communication device.

34. An apparatus that performs video coding, the apparatus comprising:
means for determining that a current block of the video data is encoded using an intra motion compensation (IMC) mode, wherein the current block is in a frame of video;
means for determining an offset vector for a first color component of the current block of the video data;
means for locating, in the frame of video, a reference block of the first color component using the offset vector;
means for modifying the offset vector to generate a modified offset vector in response to the offset vector pointing to a sub-pixel position for a second color component of the current block of video data;
means for locating, in the frame of video, a reference block for the second color component using the modified offset vector; and,
means for coding the current block based on the reference block for the first color component and the reference block for the second color component.

35. The apparatus of claim 34, wherein the first color component comprises a luma component of the current block and the second color component comprises a chroma component of the current block.

36. The apparatus of claim 34, wherein the modified offset vector points to an integer pixel position.

37. The apparatus of claim 34, wherein the modified offset vector points to a pixel position that is a lower precision position than the sub-pixel position.

38. The apparatus of claim 34, wherein the current block is coded using a 4:2:0 sampling format.

39. The apparatus of claim 34, wherein the current block is coded using a 4:2:2 sampling format.

40. The apparatus of claim 34, wherein the means for modifying the offset vector comprises means for modifying the offset vector to generate a modified offset vector that points to an integer pixel position of an array of chroma samples in response to the offset vector pointing to a sub-pixel position of the array of chroma samples.

41. The apparatus of claim 34, wherein the offset vector comprises an x-component and a y-component, and wherein the current block is coded using a 4:2:2 sampling format, and wherein modifying the offset vector to generate the modified offset vector comprises modifying the x-component.

42. The apparatus of claim 34, wherein the offset vector comprises an x-component and a y-component, and wherein the current block is coded using a 4:2:0 sampling format, and wherein the means for modifying the offset vector to generate the modified offset vector comprises means for modifying the y-component.

43. The apparatus of claim 42, wherein the means for modifying the offset vector to generate the modified offset vector further comprises means for modifying the x-component.

44. The apparatus of claim 34, wherein the apparatus comprises a video decoder, and wherein the video decoder is further configured to code the current block based on the reference block for the first color component and the reference block for the second color component by decoding the current block based on the reference block for the first color component and the reference block for the second color component.

45. The apparatus of claim 34, wherein the apparatus comprises a video encoder, and wherein the video encoder is further configured to code the current block based on the reference block by generating for inclusion in an encoded bitstream of video data one or more syntax elements identifying the offset vector.

46. A computer-readable medium storing instructions that when executed by one or more processors cause the one or more processors to:
determine that a current block of the video data is encoded using an intra motion compensation (IMC) mode, wherein the current block is in a frame of video;
determine an offset vector for a first color component of the current block of the video data;
locate, in the frame of video, a reference block of the first color component using the offset vector;
modify the offset vector to generate a modified offset vector in response to the offset vector pointing to a sub-pixel position for a second color component of the current block of video data;
locate, in the frame of video, a reference block for the second color component using the modified offset vector; and,
code the current block based on the reference block for the first color component and the reference block for the second color component.

47. The computer-readable storage medium of claim 46, wherein the first color component comprises a luma component of the current block and the second color component comprises a chroma component of the current block.

48. The computer-readable storage medium of claim 46, wherein the modified offset vector points to an integer pixel position.

49. The computer-readable storage medium of claim 46, wherein the modified offset vector points to a pixel position that is a lower precision position than the sub-pixel position.

50. The computer-readable storage medium of claim 46, wherein the current block is coded using a 4:2:0 sampling format.

51. The computer-readable storage medium of claim 46, wherein the current block is coded using a 4:2:2 sampling format.

52. The computer-readable storage medium of claim 46, wherein the one or more processors modify the offset vector by modifying the offset vector to generate a modified offset vector that points to an integer pixel position of an array of chroma samples in response to the offset vector pointing to a sub-pixel position of the array of chroma samples.

53. The computer-readable storage medium of claim 46, wherein the offset vector comprises an x-component and a y-component, and wherein the current block is coded using a 4:2:2 sampling format, and wherein the one or more processors modify the offset vector to generate the modified offset vector by modifying the x-component.

54. The computer-readable storage medium of claim 53, wherein the offset vector comprises an x-component and a y-component, and wherein the current block is coded using a 4:2:0 sampling format, and wherein the one or more processors modify the offset vector to generate the modified offset vector by modifying the y-component.

55. The computer-readable storage medium of claim 54, wherein the one or more processors further modify the offset vector to generate the modified offset vector by modifying the x-component.
